(19) United States
(12) Patent Application Publication
(10) Pub. No.: US 2021/0097423 A1
(43) Pub. Date: Apr. 1, 2021

(54) PLOT EVALUATION FOR FARM PERFORMANCE

(71) Applicant: International Business Machines Corporation, Armonk, NY (US)

(72) Inventors: JITENDRA SINGH, NOIDA (IN); SMITKUMAR NAROTAMBHAI MARVANIYA, BANGALORE (IN); JAGABONDHU HAZRA, BANGALORE (IN); SHANTANU R. GODBOLE, BANGALORE (IN); MANISH MODANI, VAISHALI NAGAR (IN)

(21) Appl. No.: 16/583,420

(22) Filed: Sep. 26, 2019

(51) Int. Cl. G06N 20/00; G06N 5/02; A01G 7/00

(52) U.S. Cl. CPC G06N 20/00; A01G 7/00; G06N 5/022

(57) ABSTRACT

An agricultural plot evaluation method, computer program product and system are provided. A processor receives a plot for evaluation. A processor determines one or more characteristics associated with the plot for evaluation. A processor identifies a plurality of similar plots based on at least one of the one or more characteristics associated with the plot for evaluation. A processor generates a prediction model for one or more features of the plurality of similar plots. A processor determines a score for the plot for evaluation based, at least in part, on the prediction model for one or more features of the plurality of similar plots.

### BACKGROUND OF THE INVENTION

The present invention relates generally to the agriculture, and more particularly to evaluating a location for farming performance.

Yields and performance in agriculture can greatly vary for a farming plot. The variety of both environmental factors and operational decisions made by a farmer contribute to a large amount of uncertainty to the financial viability of the farm. These issues are even more troublesome for considering new plots of land for potential farming sites.

### SUMMARY

Embodiments of the present invention provide a method, system, and program product to evaluate an agricultural plot. A processor receives a plot for evaluation. A processor determines one or more characteristics associated with the plot for evaluation. A processor identifies a plurality of similar plots based on at least one of the one or more characteristics associated with the plot for evaluation. A processor generates a prediction model for one or more features of the plurality of similar plots. A processor determines a score for the plot for evaluation based, at least in part, on the prediction model for one or more features of the plurality of similar plots.

### BRIEF DESCRIPTION OF THE SEVERAL VIEWS OF THE DRAWINGS

FIG. 1 is a functional block diagram illustrating a networked environment, in accordance with an exemplary embodiment of the present invention.

FIG. 2 illustrates operational processes of a plot evaluation program, on a computing device within the environment of FIG. 1, in accordance with an exemplary embodiment of the present invention.

FIG. 3 depicts a flow diagram of generating a plot score, on a computing device within the environment of FIG. 1, in accordance with an exemplary embodiment of the present invention.

FIG. 4 depicts an example screenshot of a plot evaluation program, on a computing device within the environment of FIG. 1, in accordance with an exemplary embodiment of the present invention.

FIG. 5 depicts a block diagram of components of the computing device executing a plot evaluation program, in accordance with an exemplary embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

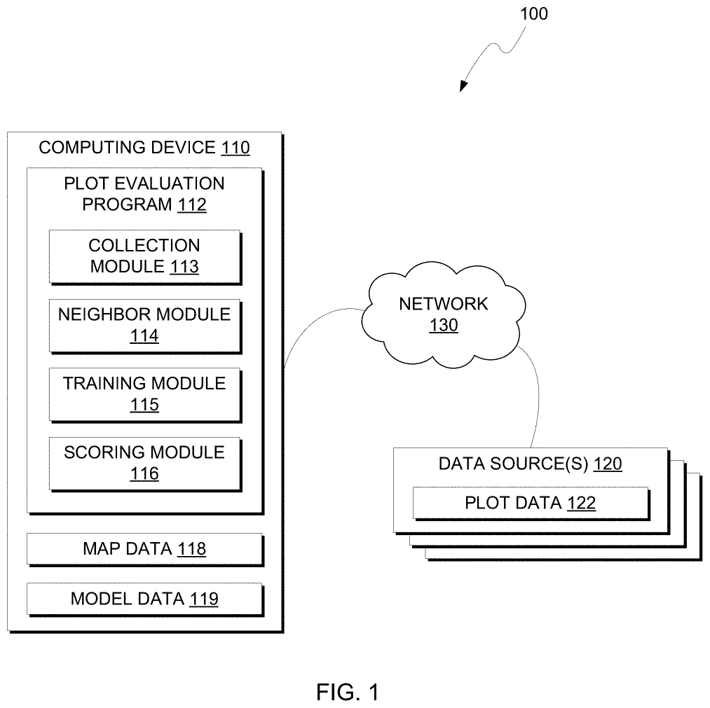

The present invention will now be described in detail with reference to the Figures. FIG. 1 is a functional block diagram illustrating networked environment, generally designated 100, in accordance with one embodiment of the present invention. Networked environment 100 includes computing device 110 and data source(s) 120 connected over network 130. Computing device 110 includes plot evaluation program 112, map data 118 and model data 119. Plot evaluation program 112 includes collection module 113, neighbor module 114, training module 115 and scoring module 116. Data source(s) 120 includes plot data 122.

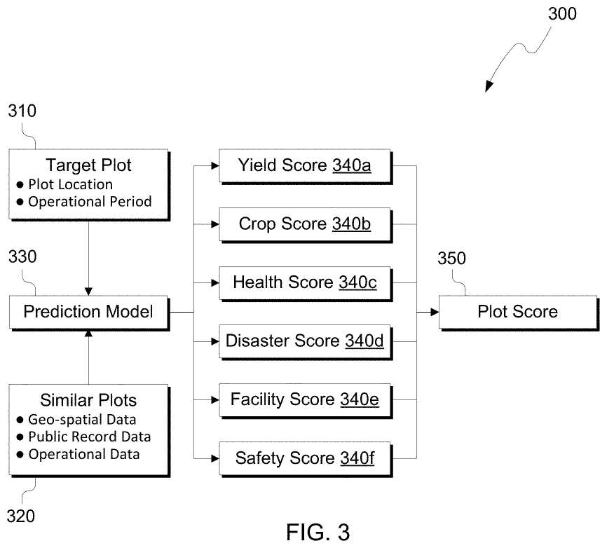

In various embodiments of the present invention, computing device 110 and data sources(s) 120 can each be a standalone device, a server, a laptop computer, a tablet computer, a netbook computer, a personal computer (PC), or a desktop computer. In another embodiment, computing device 110 and data sources(s) 120 each represent a computing system utilizing clustered computers and components to act as a single pool of seamless resources. In general, computing device 110 and data sources(s) 120 can be any computing device or a combination of devices with access to includes, map data 118, model data 119, plot data 122, and is capable of executing plot evaluation program 112. Computing device 110 and data sources(s) 120 may each include internal and external hardware components, as depicted and described in further detail with respect to FIG. 3.

In this exemplary embodiment, map data 118, model data 119, and plot data 122. However, in other embodiments, map data 118, model data 119, and plot data 122 ca be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110 and data sources(s) 120, in accordance with a desired embodiment of the present invention.

In various embodiments, plot evaluation program 112 provides an evaluation of a plot of land for consideration to be utilized in agriculture or farming operations. Plot evaluation program 112 receives a location from a user indicating the location of the plot. In some embodiments and scenarios, the location is indicated by a point location (e.g., a latitude and longitude) of the plot with an approximate acreage or size of the plot. In other embodiments and scenarios, the location is indicated by a border or shape of the plot to be evaluated. In some embodiments, plot evaluation program 112 receives one or more crops or other agricultural product that is being considered to be produced on the plot. Based on the location of the plot, plot evaluation program 112 determines nearby farms based on map data 118. Map data 118 includes geo-spatial data or other map representations that indicate the location of farms and other agricultural operations. In some embodiments, map data 118 also includes the operational characteristics of the other farm plots such as, but not limited to, the type of crops or product grown at each plot. While the following focuses on evaluating a potential plot, one of ordinary skill in the art will appreciate that plot evaluation program 112 also can be utilized to perform historic analysis of any plot as well without deviating from the invention.

In various embodiments, collection module 113 retrieves information regarding other farming plots from data source(s) 120. Data source(s) 120 include a variety of public or private data sources that provide information regarding the location and other operational characteristics of farm plots. Data source(s) 120 include plot data 122 which provide information regarding the operations of a plot including, but not limited to, facility type, crop(s) or other resources produced, water quality, soil moisture and other information regarding each plot's conditions and operations. Additionally, data source(s) 120 include information regarding the economic or financial performance of each plot, such as, but not limited to, the value of crops produced by each plot, crop yields for each plot, pest or disease information, and natural disaster information. Furthermore, data source(s) 120 include various mapping services and data sources such as, but not limited to, satellite imaging, plot or parcel mapping or zoning, and any other Geographic Information System (GIS) related data source.

In various embodiments, plot evaluation program 112 identifies similar plots to the plot received for evaluation. Based on map data 118, neighbor module 114 plot evaluation program 112 identifies similar plots based on location and similar operational and environmental qualities. For example, plot evaluation program 112 identifies similar plots as plots within a certain distance of the location to be evaluated. As another example, plot evaluation program 112 identifies similar plots as plots that produce the same, or similar, resource or crop as the location to be evaluated.

Based on the identified similar plots, plot evaluation program 112 generates model data 119. Model data 119 includes a feature-based, machine-learning classifier model that evaluates plots based on various features such as, but limited to, crop price, crop yield, crop health, plot safety, and plot facilities. Training module 115 generates model data 119 for the identified similar plots to generate a score for the neighboring plots for each feature included in in model data 119. Collection module 113 retrieves plot data 122 from data source(s) 120 regarding the similar plots to identify historic data related to the included features of model data 119. Based on the historic data related to the included features of model data 119 for the similar plots, training module 115 generates a predicted value for similar plots for each feature in model data 119.

Based on model data 119, plot evaluation program 112 determines a score for the identified plot to be evaluated. For each feature in model data 119, scoring module 116 of plot evaluation program 112 predicts a value for the features based on the plot data 122 of similar plots previously identified. For example, for a “crop yield” feature in model data 119, scoring module 116 gathers plot data 122 for yields of plots with similar crops. Based on the yields of similar plots, scoring module 116 predicts a yield for the targeted plot being evaluated.

In various embodiments, plot evaluation program 112 determines a score for the identified plot to be evaluated by combining the various feature scores in derived from model data 119. Scoring module 116 combines the feature scores as a weighted sum of each feature score, resulting in a plot score for the evaluated plot. In various embodiments, the plot score indicates the predicted performance of the farm. Based on the feature-based classifier model in model data 119, scoring module 116 analyzes similar plots in order to predict how well the plot selected for evaluation will perform.

In various embodiments, training module 115 of plot evaluation program 112 updates model data 119 based on machine learning (ML) analysis of scoring module 116. As scoring module 116 generates scores for various plots, training module 115 re-evaluates the predictions made for the plots to further train and enhance model data 119. For example, if a previously predicted plot score for a plot indicated the plot would be successful (i.e., the plot score is a above a threshold value) then sometime after plot data 122 indicates that the plot was not successful, then training module 115 updates model data 119 to re-train the classifier model with the newly provided data in plot data 122 for the plot.

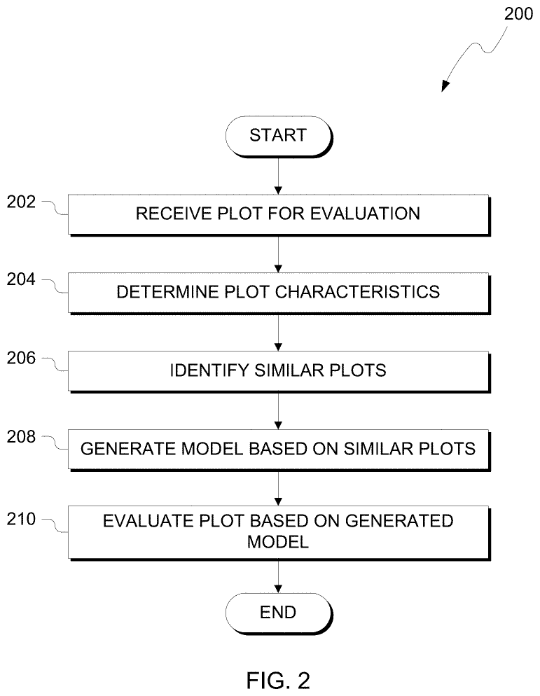

FIG. 2 illustrates operational processes, generally designated as 200, of plot evaluation program 112, on computing device 110 within the environment of FIG. 1. In process 202, plot evaluation program 112 receives a plot for evaluation. In some scenarios, plot evaluation program 112 receives a point location (e.g., latitude and longitude) for the potential site for a farming plot to be located. In other scenarios, plot evaluation program 112 receives a boundary or area for which the plot is to be located.

In process 204, plot evaluation program 112 determines the characteristics of the plot. Based on the location or area received in process 202, plot evaluation program 112 determines various environmental characteristics associated with the plot including, but not limited to, soil type, water access, road access, water quality and other environmental characteristics that may impact crop growth. Based on map data 118, plot evaluation program 112 determines the environmental characteristics for the given location. For larger areas or plots, plot evaluation program 112 may determines an average for various environmental characteristics across the area of the plot in scenarios where environmental characteristics may vary for the plot.

Additionally, in process 204, plot evaluation program 112 various operational characteristics associated with the plot including, but not limited to, proposed crops to be grown, facilities to be built, irrigation systems, pest and disease control programs, natural disaster protections (e.g., floodwalls), and other operational processes or facilities the plot is proposed to have included when the plot becomes operational.

In process 206, plot evaluation program 112 identifies similar plots based on the determined environmental and operational characteristics of the proposed plot. Based on the proposed location, plot evaluation program 112 determines similar plots that are nearby and share similar environmental and operational characteristics of the proposed plot. In some scenarios, the environmental and operational characteristics of the proposed plot may not have many or any nearby plots with similar characteristics. In such scenarios, plot evaluation program 112 broadens the search for similar plots to other further away plots. Or in similar scenarios, plot evaluation program 112 includes plots with similar characteristics.

In process 208, plot evaluation program 112 generates model data 119 based on the identified similar plots in process 206. Model data 119 is a feature-based classifier model. A feature-based model comprises various features mapped to a respective dimension in a variable space of the values that correspond to said features. For example, model data 119 can be composed one or more, but not limited to, of the following feature dimensions: facility features, safety features, crop health, crop price and crop yield. For each plot, plot evaluation program 112 maps each feature for each similar plot to a corresponding multidimensional features space. Based on the groupings of features in the feature space, plot evaluation program 112 determines expected values for each feature based on the clustering or arrangement of the various similar plots' features. For example, plot evaluation program 112 performs nearest neighbor or nearest centroid pattern recognition to determine a predicted or expected value for each feature across all identified similar plots. One of ordinary skill in the art will appreciate that any classifier model may be used without deviating from the invention. For example, model data 119 may include, but not limited to, one or more of the following classifier models: linear classifiers and regression analysis, cluster or k nearest-neighbor, Bayes classifiers, or neural networks.

In process 210, plot evaluation program 112 determines a plot score for the plot being evaluated. Based on the model data 119, plot evaluation program 112 determines one or more predicted or expected values for the evaluated plot based on machine-learning feature classification of similar plots (process 208). Plot evaluation program 112 combines each expected feature value to generate a plot score. In various embodiments, plot evaluation program 112 generates a plot score based on a weighted sum of each expected feature derived from model data 119. The combined score of each feature indicates the potential success of the plot for farming operations with the given characteristics determined and received in processes 202 and 204, where plot scores above a threshold value indicate a potentially successful agriculture operation at the proposed plot and lower scores would indicate a smaller potential for success.

In various embodiments, the generated plot score may be used to evaluate the potential success for agriculture operations in connection with lending or financing requests. Typical solutions to agricultural financing only look at the financial viability of the proprietor and not necessarily the environmental and operational characteristics of similar plots. By utilizing a machine-learning based classifier model, embodiments of the present invention provide better forecasting and predictive techniques to generate a more accurate assessment of a potential agricultural operation's success.

FIG. 3 depicts a flow diagram, generally designated 300, of generating a plot score by plot evaluation program 112. In various embodiments, plot evaluation program 112 receives a plot for evaluation as Target Plot 310. Target Plot 310 includes information such as, but not limited to, a plot's location or boundaries, an operational period or season, crop or produce to be grown, and the like as discussed herein.

Based on the information provided by Target Plot 310, plot evaluation program 112 identifies Similar Plots 320 that have similar qualities as Target Plot 310. Plot evaluation program 112 identifies Similar Plots 320 based a comparisons of plot data 122 from data source(s) 120 to the information provided by Target Plot 310. In one example, plot evaluation program 112 identifies Similar Plots 320 based on Geo-spatial data describing the location of other plots in plot data 122. Geo-spatial data includes coordinates or other indicative information of the location of other plots and based on the location of Target Plot 310, plot evaluation program 112 identifies Similar Plots 320 that are within a distance from Target Plot 310.

In another example, plot evaluation program 112 identifies Similar Plots 320 based on the crop or produce to be grown on Target Plot 310. Plot evaluation program 112 identifies plots in plot data 122 with the same or similar types of crops as to be grown in Target Plot 310, such as provided in public record data or operational data provided by plot operators or other parties. In this example, plot evaluation program 112 identifies Similar Plots 320 based on other plots in plot data that grow similar crops. One of ordinary skill in the art will appreciate that plot evaluation program 112 may identify Similar Plots 320 based on any similar quality or aspect of Target Plot 310 without deviating from the invention. Example plot qualities or aspects for similarity between plots may include, but are not limited to, location, crop types, seasonal operations, facilities, safety and pest control programs, and the like.

In various embodiments, plot evaluation program 112 provides Prediction Model 330 with Target Plot 310 and Similar Plots 320. Prediction Model 330 is a machine-learning model stored in model data 119 that is trained based on various evaluations of plots in plot data 122. Example machine learning model include, but are not limited to, decision trees, neural networks, or Bayesian networks. In some scenarios, the training of Prediction Model 330 may include supervised training by one or more users. Based on the initial scoring of a plot, a user evaluates the plot score and adjust any dimension or aspect of the plot score. Based on the evaluation, plot evaluation program 112 adjust model data 119 of Prediction Model 330 to reflect the supervised adjustment to Prediction Model 330. In other scenarios, the training of Prediction Model 330 may include unsupervised training provided by plot evaluation program 112 without a user's input. For example, plot evaluation program 112 retrieves plot data 122 for a plot that was previously evaluated and is now, at some time after the evaluation, operational. Based on the current operational data of the previously evaluated plot, plot evaluation program 112 re-trains Prediction Model 330 with the updated operational data.

In various embodiments, prediction model 330 generates various feature scores 340 that represent the target plot's predicted performance for each feature. Prediction model 330 generates at least one of the following feature scores 340: yield score 340a, crop score 340b, health score 340c, disaster score 340d, facility score 340e and safety score 340f. One of ordinary skill in the art will appreciate that additional plot features may be included in feature scores 340 or that one or more feature scores 340 may be removed without deviating from the invention.

Yield Score 340a reflects a predicted yield of crops, produce or other resource for Target Plot 310. Prediction Model 330 generates a prediction for the yield of Target Plot 310. Based on various information regarding Target Plot 310, such as, but not limited to, crop type, location, and soil and weather conditions, Prediction Model 330 determines a predicted yield for Target Plot 310. Additionally, prediction model 330 generates a yield prediction for Similar Plots 320, such as plots with similar locations and crops or produce. In some scenarios, prediction model 330 interpolates historical data from retrieved from plot data 122 to determine a similar plot's predicted yield. When training prediction model 330, plot evaluation program 112 may adjust the interpolation method to update feature scores. In various embodiments, Prediction Model 330 combines or aggregates the yield scores for Similar Plots 320. Yield Score 340a reflects the ratio between the predicted yield for Target Plot 310 and the aggregate of yields for Similar plots 320. In scenarios where the ratio is greater than 1, Yield Score 240a indicates that Target Plot 310 will have better performance than Similar Plots 320.

Crop Score 340b reflects an economic value of the predicted yields for the crops or produce of Target Plot 310. Based on the crops or produce associated with Target Plot 310, Prediction Model 330 generates a predicted value for the crops or produce. In various embodiments, plot evaluation program 112 retrieves pricing or sales data for Similar Plots 320. For example, a public record source of data source(s) 120 provides the sale price of crops for a plot in Similar Plots 320. If specific data regarding sale price of crops for Similar Plots 320 cannot be found, then plot evaluation program 112 retrieves pricing or sales data for other plots that share at least one feature of Similar Plots 320 (e.g., other plots that sale or produce the same crop types). In various embodiments, Prediction Model 330 combines or aggregates the value of crops for Similar Plots 320, or other plots represented in plot data 122. Crop Score 340b reflects the average crop value for Target Plot 310 relative to Similar Plots 320.

Health Score 340c reflects a prediction that Target Plot 310 is susceptible to risks that may impact the predicted yield. For both Target Plot 310 and Similar Plots 320, Prediction Model 330 generates a predicted value for the following dimensions that may impact yield: pest infestation, crop disease, soil moisture, and nutrient or fertilizer usage. Based on historic records in plot data 122 of Similar Plots 320, plot evaluation program 112 identifies impacts to previous yields for Similar Plots 320. Based on comparisons with other plots in Similar Plots 320, plot evaluation program 112 identifies which impacts caused the drop in previous yields. For each crop health impact identified by plot evaluation program 112 found in Similar Plots 320, Prediction Model 330 lowers Health Score 340c. For example, ten Similar Plots 320 are identified with five similar plots found to have pest infestations. Prediction Model 330 divides

Yield Score 340a by the number of plots with prior crop health issues (e.g., a factor of five). As more Similar Plots 320 have had prior risk factors for crop health, Prediction Model 330 lowers Health Score 340c.

Disaster Score 340d reflects a prediction that Target Plot 310 is susceptible to natural risks or “Force Majeure” that may impact the predicted yield. Much like Health Score 340c, plot evaluation program 112 identifies previous natural disaster occurrences for Similar Plots 320. Based on the number off occurrences of natural disaster occurrences for Similar Plots 320, Prediction Model 330 divides Yield Score 340a by the number of occurrences. In some embodiments, plot evaluation program 112 identifies the severity of the previous natural disaster occurrences and weights more severe natural disaster occurrences for Similar Plots 320.

Facility Score 340e reflects the number and types of facilities that are present, or to be built, at Target Plot 310. Prediction Model 330 includes a list of types of facilities that may improve crop yield. For each type of facility offered, Prediction Model 330 increases Facility Score 340e and normalizes or averages the Facility Score 340e based on the amount of facilities included in Prediction Model 330. Example facilities include, but are not limited to, irrigation facilities and capabilities, storage facilities, roads and other access facilities, and the like. Safety Score 340f reflects the number and types of security operations or programs that are present, or to be built, at Target Plot 310. Prediction Model 330 includes a list of types of security operations or programs. For each type of operation provided, Prediction Model 330 increases Safety Score 340f and normalizes or averages the Safety Score 340f based on the amount of operations included in Prediction Model 330. Example security operations or programs include, but are not limited to, cameras, motion detectors, access controls, and the like.

In some embodiments, plot evaluation program 112 aggregates feature scores 340 to generate Plot Score 350 for Target Plot 310. Each feature score 340 is initially assigned a weight (e.g., a uniform weight is initially assigned to each feature). During training, plot evaluation program 112 redistribute the weights to match the classified training data provided. In other embodiments, feature scores 340 are mapped to a feature space, with each dimension of the feature space mapped to a score of feature score. In such scenarios, feature scores 340 for Similar Plots 320 are also mapped to the feature space. Plot evaluation program 112 performs machine-learning based classification of Target Plot 310. Similar Plots 320 are identified with one or more classifications that indicate the successfulness of each plot. Based on the pattern matching of the feature scores of Target Plot 310 and the classified, either supervised or unsupervised, Similar Plots 320, plot evaluation program 112 determines a classification for Target Plot 310.

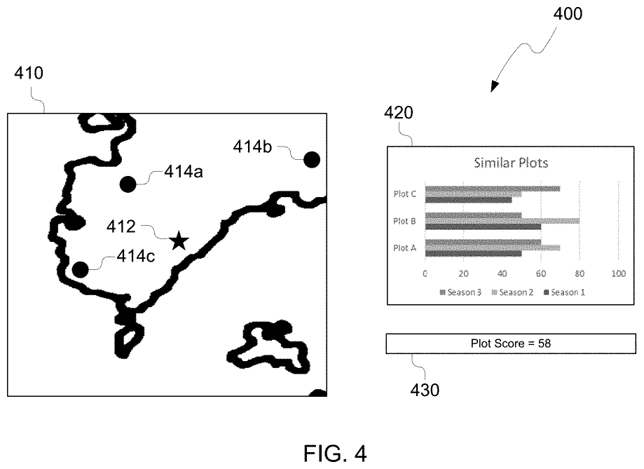

FIG. 4 depicts an example screenshot, generally designated 400, of plot evaluation program 112. Screenshot 400 includes map area 410, historic scores 420 and target score 430. Map area 410 renders a map of the surrounding area for target plot 412 as well as any similar plots 414a-c that fall within the rendered area of the map. One of ordinary skill in the art will appreciate that any number of similar plots may be rendered by changing the area rendered in Map Area 410. Historic scores 420 show the previous plot score for similar plots 414a-c. In this example screenshot 400, the similar plot scores are further decomposed into seasonal scores. Target score 430 depicts the plot score for target plot 412.

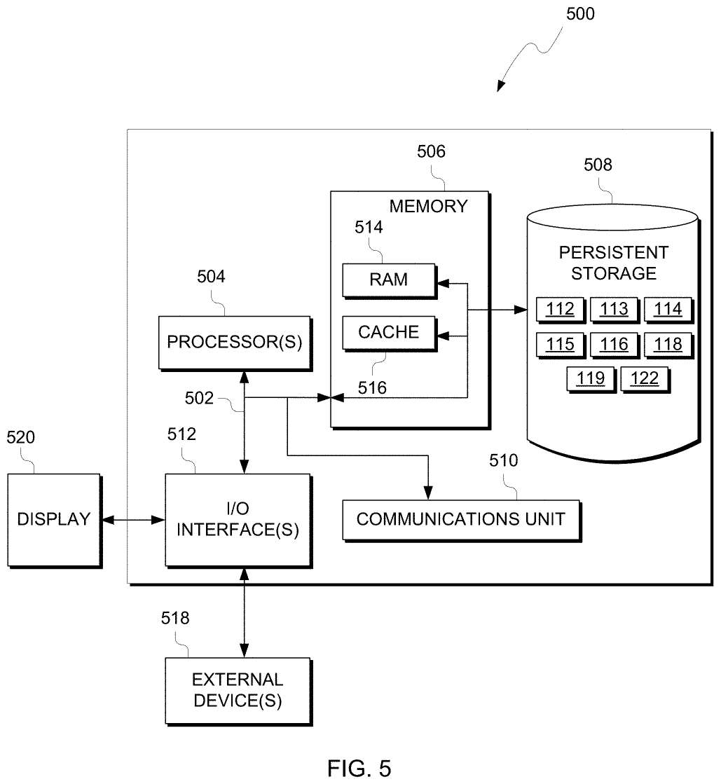

FIG. 5 depicts a block diagram, 500, of components of computing device 110, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 110 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Plot evaluation program 112, collection module 113, neighbor module 114, training module 115 and scoring module 116, map data 118, model data 119, and plot data 122 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 130. In these examples, communications unit 510 includes one or more network interface cards. Communications unit 510 may provide communications through the use of either or both physical and wireless communications links. Plot evaluation program 112, collection module 113, neighbor module 114, training module 115 and scoring module 116, map data 118, model data 119, and plot data 122 may be downloaded to persistent storage 508 through communications unit 510.

I/O interface(s) 512 allows for input and output of data with other devices that may be connected to computing device 110. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., Plot evaluation program 112, collection module 113, neighbor module 114, training module 115 and scoring module 116, map data 118, model data 119, and plot data 122, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
receiving, by one or more processors, a plot for evaluation;
determining, by the one or more processors, one or more characteristics associated with the plot for evaluation;
identifying, by the one or more processors, a plurality of similar plots based on at least one of the one or more characteristics associated with the plot for evaluation;
generating, by the one or more processors, a prediction model based, at least in part on, one or more features of the plurality of similar plots; and
determining, by the one or more processors, a score for the plot for evaluation based, at least in part, on the prediction model for one or more features of the plurality of similar plots.

2. The method of claim 1, the method further comprising:
retrieving, by one or more processors, operational data regarding the plot; and
training, by one or more processors, the prediction model based on the operational data regarding the plot.

3. The method of claim 2, wherein one or more weights of the prediction model are updated based on the training of the prediction model.

4. The method of claim 1, wherein the one or more characteristics associated with the plot for evaluation include one or more environmental characteristics of the plot for evaluation.

5. The method of claim 3, wherein the one or more environmental characteristics include one or more of the following: soil type, water access, road access, or water quality.

6. The method of claim 1, wherein the one or more characteristics associated with the plot for evaluation include one or more operational characteristics of the plot for evaluation.

7. The method of claim 6, wherein the one or more operational characteristics include one or more of the following: proposed crops, proposed facilities, pest and disease control programs, or natural disaster protections.

8. A computer program product comprising:
one or more computer-readable storage media and program instructions stored on the one or more computer-readable storage media, the program instructions comprising:
program instructions to receive a plot for evaluation;
program instructions to determine one or more characteristics associated with the plot for evaluation;
program instructions to identify a plurality of similar plots based on at least one of the one or more characteristics associated with the plot for evaluation;
program instructions to generate a prediction model based, at least in part on, one or more features of the plurality of similar plots; and
program instructions to determine a score for the plot for evaluation based, at least in part, on the prediction model for one or more features of the plurality of similar plots.

9. The computer program product of claim 8, the program instructions further comprising:
program instructions to retrieve operational data regarding the plot; and
program instructions to train the prediction model based on the operational data regarding the plot.

10. The computer program product of claim 9, wherein one or more weights of the prediction model are updated based on the training of the prediction model.

11. The computer program product of claim 8, wherein the one or more characteristics associated with the plot for evaluation include one or more environmental characteristics of the plot for evaluation.

12. The computer program product of claim 11, wherein the one or more environmental characteristics include one or more of the following: soil type, water access, road access, or water quality.

13. The computer program product of claim 8, wherein the one or more characteristics associated with the plot for evaluation include one or more operational characteristics of the plot for evaluation.

14. The computer program product of claim 13, wherein the one or more operational characteristics include one or more of the following: proposed crops, proposed facilities, pest and disease control programs, or natural disaster protections.

15. A computer system comprising:
one or more computer processors;
one or more computer readable storage media; and
program instructions stored on the computer readable storage media for execution by at least one of the one or more processors, the program instructions comprising:
program instructions to receive a plot for evaluation;
program instructions to determine one or more characteristics associated with the plot for evaluation;
program instructions to identify a plurality of similar plots based on at least one of the one or more characteristics associated with the plot for evaluation;
program instructions to generate a prediction model based, at least in part on, one or more features of the plurality of similar plots; and
program instructions to determine a score for the plot for evaluation based, at least in part, on the prediction model for one or more features of the plurality of similar plots.

16. The computer system of claim 15, the program instructions further comprising:
program instructions to retrieve operational data regarding the plot; and
program instructions to train the prediction model based on the operational data regarding the plot.

17. The computer system of claim 16, wherein one or more weights of the prediction model are updated based on the training of the prediction model.

18. The computer system of claim 15, wherein the one or more characteristics associated with the plot for evaluation include one or more environmental characteristics of the plot for evaluation.

19. The computer system of claim 18, wherein the one or more environmental characteristics include one or more of the following: soil type, water access, road access, or water quality.

20. The computer system of claim 15, wherein the one or more characteristics associated with the plot for evaluation include one or more operational characteristics of the plot for evaluation.
